(19) United States
(12) Patent Application Publication
(10) Pub. No.: US 2017/0076222 A1
(43) Pub. Date: Mar. 16, 2017

(54) SYSTEM AND METHOD TO COGNITIVELY PROCESS AND ANSWER QUESTIONS REGARDING CONTENT IN IMAGES

(71) Applicant: International Business Machines Corporation, Armonk, NY (US)

(72) Inventors: Mitesh M. Khapra, Bangalore (IN); Vikas Chandrakant Raykar, Bangalore (IN); Karthik Sankaranarayanan, Bangalore (IN)

(21) Appl. No.: 14/853,973

(22) Filed: Sep. 14, 2015

(51) Int. Cl. G06N 99/00; G06F 17/28; G06Q 30/06

(52) U.S. Cl. CPC G06N 99/005; G06Q 30/0623; G06F 17/28

(57) ABSTRACT

Methods and arrangements for cognitively processing image content. At least one image is accessed, wherein the at least one image comprises a compilation of objects. A plurality of verbal cues are received from a user relating to the at least one image, and the at least one received verbal cue is parsed. Using the parsed verbal cues, at least one object is identified in the compilation of objects, and at least one of the verbal cues related to the identified object is classified. A response to the user is generated, wherein the response comprises a natural language acknowledgement based on the classifying of the at least one verbal cue. Other variants and embodiments are broadly contemplated herein.

### BACKGROUND

Interactive shopping, e.g., via a user interface on a desktop or laptop computer, or via a mobile device such as a tablet computer or mobile phone (e.g., “smartphone”), has gained in popularity in recent years. However, conventional arrangements have been very limiting and lacking in versatility, and to date most consumers have been deprived of a more extensive and encompassing shopping experience that may well better suit their needs and preferences.

Generally, traditional interactive shopping systems are set up such that the combination of media and information regarding purchasable items are displayed on a screen of a device. Interaction between the user (consumer) and the media displaying consumer goods usually occurs via a specific website or from an interactive screen containing a point and click mechanism to establish the item that the user wishes to purchase. Both of these interactions are carried out through means of non-verbal communication and limited to one visual image screen wherein the user must interact with the system by explicitly manipulating this point and click mechanism indicating the location of the item (the item's coordinates on the visual image). Challenges are encountered by consumers interacting with systems which display items they may wish to purchase when the items are visualized in a video or streaming venue. For example, an individual can be watching a movie or a televised event and wish to verbally make an interactive inquiry regarding costuming or athletic attire and where to purchase such items.

### BRIEF SUMMARY

In summary, one aspect of the invention provides a method of cognitively processing image content, said method comprising: utilizing at least one processor to execute computer code that performs the steps of: accessing at least one image, wherein the at least one image comprises a compilation of objects; receiving a plurality of verbal cues from a user relating to the at least one image; parsing the plurality of received verbal cues; identifying, using the parsed verbal cues, at least one object in the compilation of objects; classifying at least one of the verbal cues related to the identified object; and generating a response to the user, wherein the response comprises a natural language acknowledgement based on the classifying of the at least one of the verbal cues.

Another aspect of the invention provides an apparatus for cognitively processing image content, said apparatus comprising: at least one processor; and a computer readable storage medium having computer readable program code embodied therewith and executable by the at least one processor, the computer readable program code comprising: computer readable program code configured to assess at least one image, wherein each trajectory comprises a compilation of objects; computer readable program code configured to receive a plurality of verbal cues from a user relating to the at least one image; computer readable program code configured to parse the plurality of received verbal cues; computer readable program code configured to identify, using the parsed verbal cues, at least one object in the compilation of objects; computer readable program code configured to classify at least one of the verbal cues related to the identified object; and computer readable program code configured to generate a response to the user, wherein the response comprises a natural language acknowledgement based on the classifying of the at least one of the verbal cues.

An additional aspect provides a computer program product for cognitively processing image content, said computer program product comprising: a computer readable storage medium having computer readable program code embodied therewith, the computer readable program code comprising: a computer readable program code configured to assess at least one image, wherein each trajectory comprises a compilation of objects; computer readable program code configured to receive a plurality of verbal cues from a user relating to the at least one image; computer readable program code configured to parse the plurality of received verbal cues; computer readable program code configured to identify, using the parsed verbal cues, at least one object in the compilation of objects; computer readable program code configured to classify at least one of the verbal cues related to the identified object; and computer readable program code configured to generate a response to the user, wherein the response comprises a natural language acknowledgement based on the classifying of the at least one of the verbal cues.

A further aspect of the invention provides a method comprising: accessing at least one image, wherein the at least one image comprises at least one purchasable object; receiving at least one verbal question from a user relating to the at least one image, wherein the at least one verbal question relates to shopping for the purchasable object; utilizing a Semantic Entity-Relation Graph on the image of the purchasable object and the at least one verbal question, wherein the Semantic-Entity-Relation graph parses the at least one verbal question and searches a corpus for at least one object similar to the purchasable object; and thereupon generating a natural language response to the verbal question regarding the purchasable object.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 depicts an interactive question answering system.

FIG. 2 depicts an arrangement for parsing video frames or images to assist in interactive shopping.

FIG. 3 schematically illustrates components of a semantic entity-relation graph (SERG) engine.

FIG. 4 schematically illustrates steps of a question and answer process.

FIG. 5 sets forth a process more generally for cognitively processing image content.

FIG. 6 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

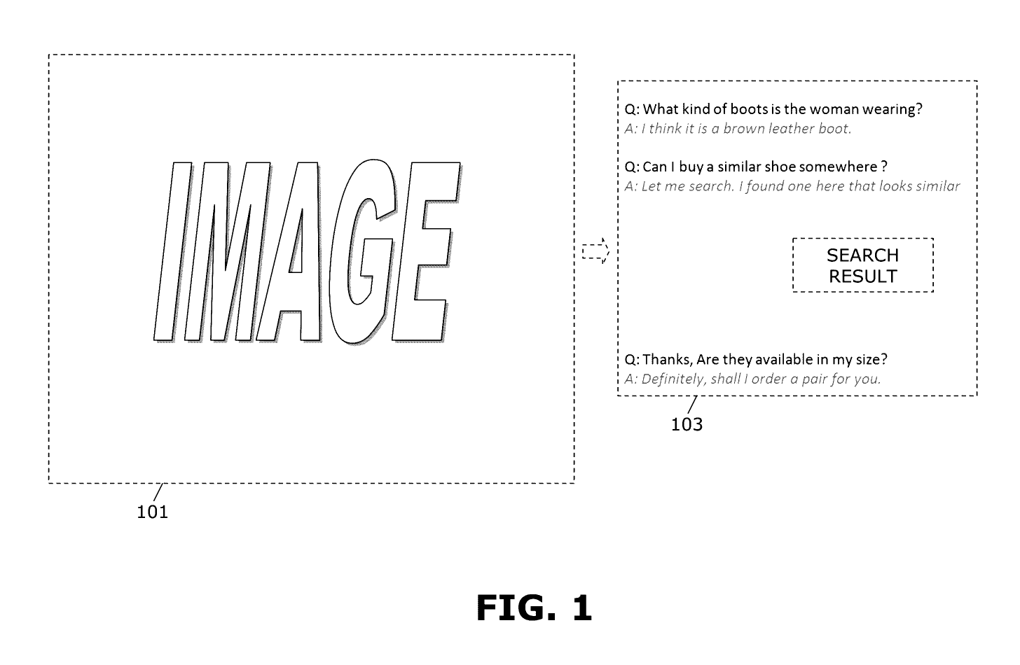

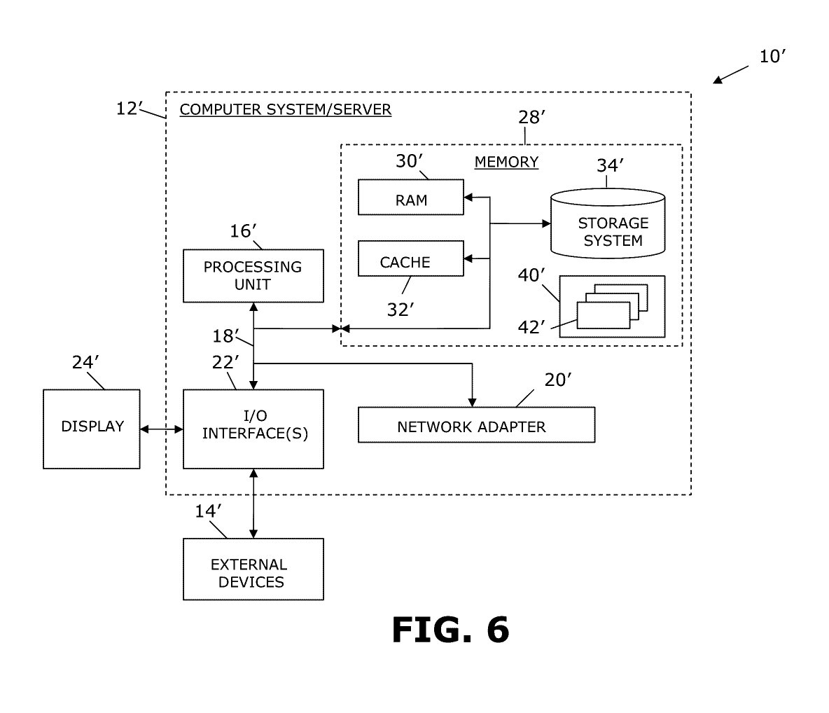

Specific reference will now be made here below to FIGS. 1-5. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 6. In accordance with an exemplary embodiment, most if not all of the process steps, components and outputs discussed with respect to FIGS. 1-5 can be performed or utilized by way of a processing unit or units and system memory such as those indicated, respectively, at 16′ and 28′ in FIG. 6, whether on a server computer, a client computer, a node computer in a distributed network, or any combination thereof.

Broadly contemplated herein, in accordance with at least one embodiment of the invention, are methods and arrangements for automatically answering questions from humans about an image or video in natural language, tailored for interactive shopping. As such, this can involve a user, when watching a video/image, being able to ask any question about the content in the video/image, with the system answering the question automatically via understanding the content in the video. This can also involve the system further suggesting where to buy items similar to those in the image.

The features discussed above, and others, relating to at least one embodiment of the invention, will be better appreciated from the discussion which follows.

In accordance with at least one embodiment of the invention, a proposed video/image cognitive QA (question and answer) system is realized via several distinct measures. Thus, given a video or an image, there is automatically generated a Semantic Entity Attribute Relation Graph (SERG). Also involved is classification of questions into types, along with training of a classifier wherein the classifier is defined as a standard logistic regression trained with Question/Answer pairs with features providing an ability to answer questions based on the SERG, thus generating a SERG containing knowledge beyond image. Further involved is the finding of similar images and text in a large corpus as well as a domain specific ontology. The SERG generator takes input from multiple algorithms as well as different sources such as, but not limited to, video, video and/or text corpus, and an ontology, which is then incorporated via a Conditional Random Field (CRF) based inference algorithm thus generating a final SERG. For videos a temporal aspect to this SERG generation will occur for every key frame of the video.

In accordance with at least one embodiment FIG. 1, depicts a general illustration of a cognitive interactive question and answering system detailing opportunities relating to fashion retail associated with a video or an image. As will be further appreciated herein, given an initial image 101, which could be an image of a person wearing or carrying several items, and within the image there could be labels appearing describing those items, for example, a “handbag”, “black”, “leather”, etc., an image processing system can be automatically developed that will determine question type and object classification which can then generate a Semantic Entity Attribute Relation Graph otherwise known as a SERG graph. For example, attributes can describe several features including color or shape of an object or a compilation of objects, wherein a compilation of objects comprises a plurality of objects, and relatedness of these attributes or features contained in the video image can then be assigned functional values or descriptive/semantic terms. Indicated at 103 is a sample set of questions and answers related to the image 101. In that connection, once a user inquires, via natural language, about an object or objects specific to the video, a classifier, which has been trained by the SERG graph, can generate an automatic answer to the inquiry; in the process, the classifier makes a determination by parsing the question type as well as classifying the object type. Once there is a determination by the classifier, the introduction of similar images and website connections such as e-commerce sites from a large corpus related to the classification(s) of the inquiry to the user can be made. Thus, the system has understanding of the video or image content and can therefore answer the user via natural language. The user does not need to select a specific region of the image; the user can cognitively interact with the system when a verbal question is posed.

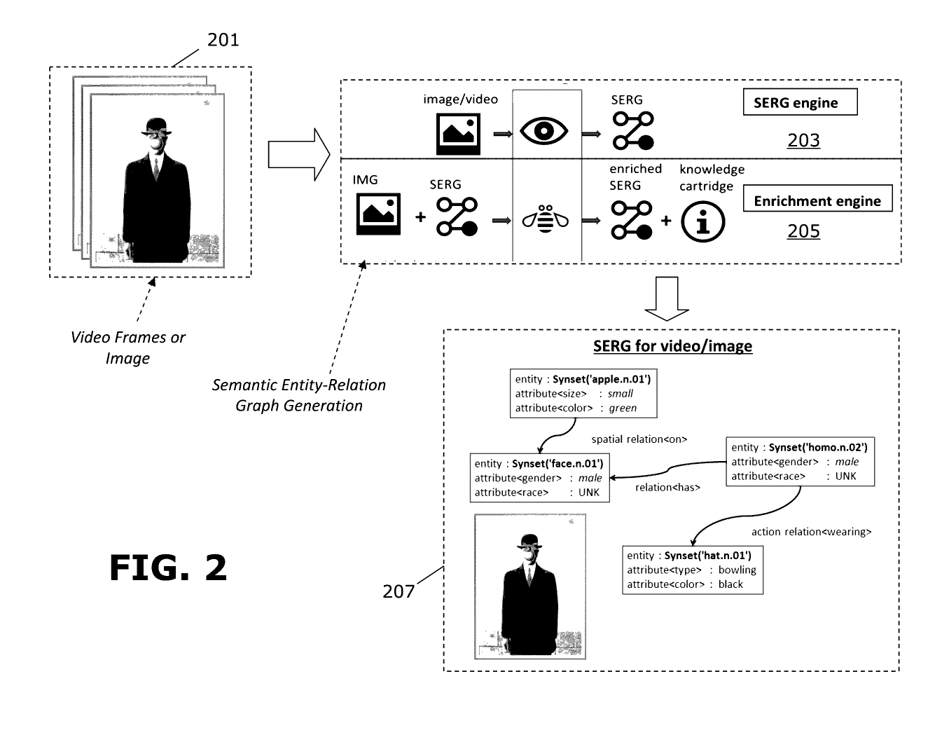

FIG. 2 depicts a general arrangement for parsing natural language inquiries regarding video frames or images to assist in interactive shopping, in accordance with at least one embodiment of the invention. An image or images taken from the video (201) can be assigned an acquired knowledge representation via a SERG engine 203 that would assess input derived from visual identification and relayed through a natural language inquiry. Via enrichment engine 205, the image is coupled with the SERG graph and is enriched with information regarding specific attributes of the grouping of objects found on the screen and integrated with information contained in a knowledge cartridge based on a predetermined corpus. The final output SERG is indicated at 207. The “synset” entities in FIG. 2 each relate to a group of data elements that are considered semantically equivalent for the purposes of information retrieval.

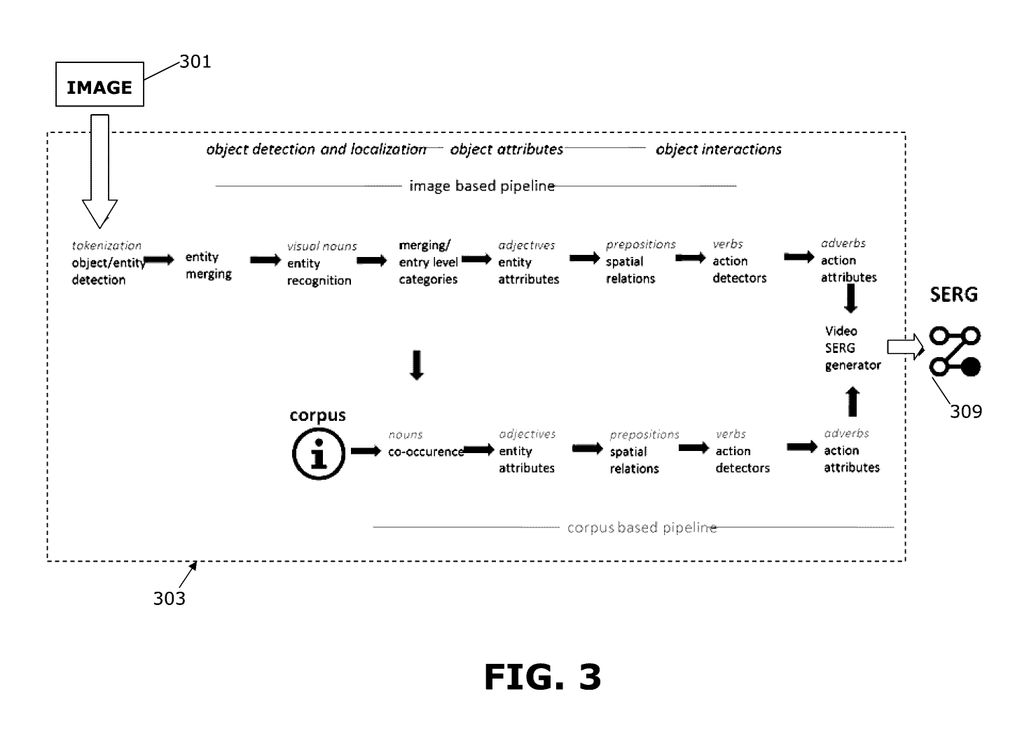

FIG. 3 schematically illustrates components of a semantic entity-relation graph (SERG) engine 303 in additional detail, in accordance with at least one embodiment of the invention; continued reference may also be made to FIG. 2. To that end, FIG. 3 shows a process flow for generating a SERG 309 (that is then fed to an enrichment engine, e.g., 205 in FIG. 2), given an input image 301. Most conventional arrangements in this regard have only dealt with identifying objects and nouns in an image, with no complete representation of the image. The SERG 309 comes to be supplemented with knowledge beyond the image, mainly from a text corpus and a domain specific ontology. The SERG engine 303 ends up taking input from multiple algorithms and different sources (e.g., video, corpus, ontology), and then integrates these via a CRF (conditional random field) based inference algorithm and generates the final SERG. (For background purposes, a non-restrictive and illustrative example of CRF-based inference can be found in: Lafferty, J., McCallum, A., Pereira, F., [2001], “Conditional random fields: Probabilistic models for segmenting and labeling sequence data”, Proc. 18th International Conf on Machine Learning, Morgan Kaufmann, pp. 282-289.) For videos there will be a temporal aspect to this and there is generated a similar SERG for every key frame in the video.

In accordance with at least one embodiment of the invention, an image based pipeline is generated by object detection and localization as well as determining object attributes. An object or entity can be identified by voice from amongst the entire image content and merged with the parsed language classifier in determining, from the voice input, language categories such as adjectives, prepositions, verbs, adverbs, etc. In a corpus based pipeline, the identified object determined by question type can be merged with concurrent language identifiers from a predetermined corpus. The question type, for example, can be associated with the name of the object, and one or more specific attributes such as color, size, shape and brand. The question type may also involve a purchase intent component, as well as specifics regarding the purchase intent such as, but not limited to, availability in the user's size or color preference. Each of the two pipelines can produce an intermediate SERG graph (or other output), and complete SERG graph 309 can be generated via combining both outputs in a video SERG generator as shown. (As noted above, this graph 309 can then be fed to an enrichment engine.)

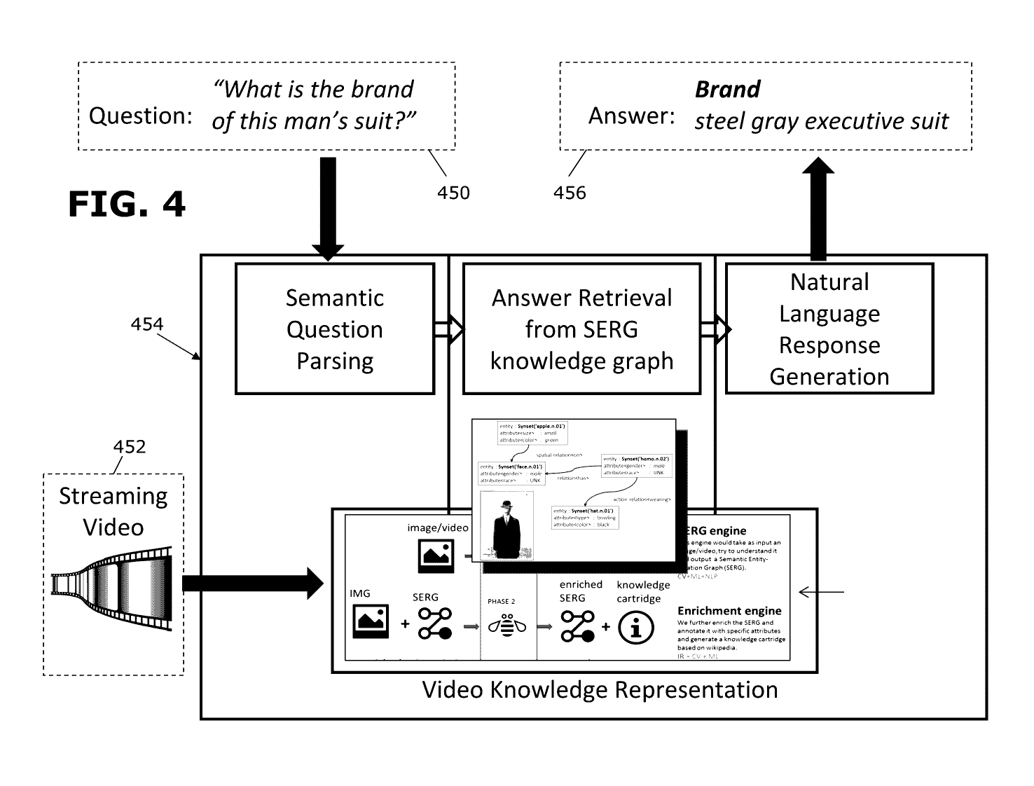

FIG. 4 schematically illustrates steps of a question and answer process, in accordance with at least one embodiment of the invention. Within a streaming video 452 containing video knowledge representation (454), semantic parsing is initiated by the verbal inquiry (450) of the user. An answer retrieval or response from the SERG knowledge graph is generated in the form of a natural language response (456) to the user.

With continued reference to FIGS. 1-4, in accordance with at least one embodiment of the invention, question type classification can proceed as follows. It can be appreciated that the features to build a question classifier to predict and answer an inquiry (e.g., using the SERG and an external domain ontology) can be engineered from the output of a suitable (semantic) parser. Various question types can include, e.g., one involving the name (category) of a certain object, e.g., “What is the lady wearing?”. Another type can be the attribute (color, size, shape, brand) of an object, e.g., “What kind of boots is the woman wearing?”. Another question type can relate to buying intent, e.g., “Can I buy a similar shoe somewhere?”. Yet another type of question can involve a yes/no binary answer, or even multiple choice answers, e.g., “Are there shoes available in my size?”

In accordance with at least one embodiment of the invention, for each question type a trained classifier is applied to predict the answer using the SERG and an external domain ontology. To this end, the classifier can embody a standard logistic regression trained with QA pairs with features extracted from the SERG and the ontology.

In accordance with at least one embodiment of the invention, to find similar images in a large corpus, a specific similarity measure can be defined on the SERG. In a variant embodiment, image autoencoders may be employed wherein an auto encoder is an artificial neural network used for efficient machine learning.

In accordance with at least one embodiment of the invention, very generally, as SERG graphs are generated and iterative updates are performed to the final SERG graphs on a per query basis, the information held within can be stored in memory or used to interact with an individual user via one or more personal device or devices. The database that is created can be stored locally per individual user and/or remotely by a third party entity or a server. The third party entity or back-end party may be, but is not limited to, a cable television company. The corpus, as identified in FIG. 2 and FIG. 3, can be a knowledge cartridge or database for images or e-commerce sites maintained by a third party and used by the program to generate the SERG graph for each video frame.

It can be appreciated from the foregoing that, in accordance with at least one embodiment of the invention, a technical improvement is represented at least via provisions for automatically answering verbal questions from humans about an image or video in natural language, tailored for interactive shopping.

In accordance with at least one embodiment of the invention, very generally, quantitative values as determined herein, or other data or information as used or created herein, can be stored in memory or displayed to a user on a screen, as might fit the needs of one or more users.

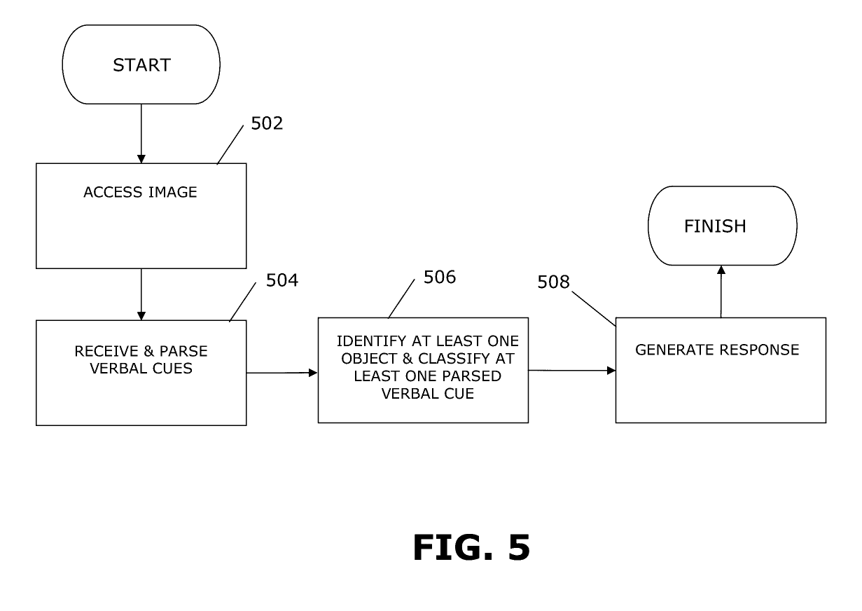

FIG. 5 sets forth a process more generally for cognitively processing image content in accordance with at least one embodiment of the invention. It should be appreciated that a process such as that broadly illustrated in FIG. 4 can be carried out on essentially any suitable computer system or set of computer systems, which may, by way of an illustrative and non-restrictive example, include a system such as that indicated at 12′ in FIG. 6. In accordance with an example embodiment, most if not all of the process steps discussed with respect to FIG. 5 can be performed by way of a processing unit or units and system memory such as those indicated, respectively, at 16′ and 28′ in FIG. 6.

As shown in FIG. 5, in accordance with at least one embodiment of the invention, at least one image is accessed, wherein the at least one image comprises a compilation of objects (502). A plurality of verbal cues are received from a user relating to the at least one image, and the at least one received verbal cue is parsed (504). Using the parsed verbal cues, at least one object is identified in the compilation of objects, and at least one of the verbal cues related to the identified object is classified (506). A response to the user is generated, wherein the response comprises a natural language acknowledgement based on the classifying of the at least one verbal cue (508).

Referring now to FIG. 6, a schematic of an example of a computing node is shown. Computing node 10′ is only one example of a suitable computing node and is not intended to suggest any limitation as to the scope of use or functionality of embodiments of the invention described herein. Regardless, computing node 10′ is capable of being implemented and/or performing any of the functionality set forth hereinabove. In accordance with embodiments of the invention, computing node 10′ may be part of a cloud network or could be part of another type of distributed or other network (e.g., it could represent an enterprise server), or could represent a stand-alone node.

In computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method of cognitively processing image content, said method comprising:
utilizing at least one processor to execute computer code that performs the steps of:
accessing at least one image, wherein the at least one image comprises a compilation of objects;
receiving a plurality of verbal cues from a user relating to the at least one image;
parsing the plurality of received verbal cues;
identifying, using the parsed verbal cues, at least one object in the compilation of objects;
classifying at least one of the verbal cues related to the identified object; and
generating a response to the user, wherein the response comprises a natural language acknowledgement based on the classifying of the at least one of the verbal cues.

2. The method according to claim 1, wherein said identifying comprises using a Semantic Entity-Relation Graph (SERG).

3. The method according to claim 1, wherein the classifying utilizes a corpus.

4. The method according to claim 1, wherein the generating a response comprises generating a Semantic Entity Relation Graph for at least one of the compilation of objects.

5. The method according to claim 4, wherein the generating further comprises modifying the Semantic Entity Relation Graph to generate a final Semantic Entity Relation Graph.

6. The method according to claim 4, wherein said generating a response comprises retrieval of a corresponding answer from said Semantic Entity Relation Graph.

7. The method according to claim 1, wherein the plurality of images is obtained from a video.

8. The method according to claim 1, wherein said classifying comprises using a classifier trained via a final Semantic Entity Related Graph and external ontology.

9. The method according to claim 1, wherein said parsing comprises using a semantic parser.

10. The method of claim 1, wherein the plurality of verbal cues relates to shopping for the at least one of the compilation of objects.

11. The method of claim 10, wherein the plurality of verbal cues relates to attributes of one the objects in said compilation of objects wherein the attributes are selected from the group consisting of colors, shapes, sizes, and brands.

12. The method according to claim 1, wherein said identifying the at least one of the objects comprises using spatial relation of the compilation of objects in the image.

13. The method according to claim 4, wherein said generating a response comprises utilizing a knowledge cartridge wherein the knowledge cartridge comprises a corpus, at least one Semantic Entity Relation Graph, and at least one website; and
wherein the knowledge cartridge is updated via machine learning.

14. An apparatus for cognitively processing image content, said apparatus comprising:
at least one processor; and
a computer readable storage medium having computer readable program code embodied therewith and executable by the at least one processor, the computer readable program code comprising:
computer readable program code configured to assess at least one image, wherein each trajectory comprises a compilation of objects;
computer readable program code configured to receive a plurality of verbal cues from a user relating to the at least one image;
computer readable program code configured to parse the plurality of received verbal cues;
computer readable program code configured to identify, using the parsed verbal cues, at least one object in the compilation of objects;
computer readable program code configured to classify at least one of the verbal cues related to the identified object; and
computer readable program code configured to generate a response to the user, wherein the response comprises a natural language acknowledgement based on the classifying of the at least one of the verbal cues.

15. A computer program product for cognitively processing image content, said computer program product comprising:
a computer readable storage medium having computer readable program code embodied therewith, the computer readable program code comprising:
a computer readable program code configured to assess at least one image, wherein each trajectory comprises a compilation of objects;
computer readable program code configured to receive a plurality of verbal cues from a user relating to the at least one image;
computer readable program code configured to parse the plurality of received verbal cues;
computer readable program code configured to identify, using the parsed verbal cues, at least one object in the compilation of objects;
computer readable program code configured to classify at least one of the verbal cues related to the identified object; and
computer readable program code configured to generate a response to the user, wherein the response comprises a natural language acknowledgement based on the classifying of the at least one of the verbal cues.

16. The computer program product according to claim 15, wherein the identifying comprises using a Semantic Entity-Relation Graph.

17. The computer program product according to claim 15, wherein the classifying utilizes a corpus.

18. The computer program product according to claim 15, wherein the generating a response comprises generating a Semantic Entity-Relation Graph for at least one of the compilation of objects.

19. The computer program product according to claim 15, wherein the identifying the at least one of the objects comprises using spatial relation of the compilation of objects in the image.

20. A method comprising:
accessing at least one image, wherein the at least one image comprises at least one purchasable object;
receiving at least one verbal question from a user relating to the at least one image, wherein the at least one verbal question relates to shopping for the purchasable object;
utilizing a Semantic Entity-Relation Graph on the image of the purchasable object and the at least one verbal question, wherein the Semantic-Entity-Relation graph parses the at least one verbal question and searches a corpus for at least one object similar to the purchasable object; and
thereupon generating a natural language response to the verbal question regarding the purchasable object.
